(19) United States
(12) Patent Application Publication
(10) Pub. No.: US 2010/0149433 A1
(43) Pub. Date: Jun. 17, 2010

(54) SIGNAL PROCESSING APPARATUS, AUDIO APPARATUS, AND METHOD OF CONTROLLING THE SAME

(75) Inventors: Doo-jin JANG, Seoul (KR); Hwi-sam KANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/568,879

(22) Filed: Sep. 29, 2009

(30) Foreign Application Priority Data
Dec. 12, 2008 (KR) 10-2008-0126569

(51) Int. Cl. H04N 5/60

(52) U.S. Cl. 348/738; 348/E05.122

(57) ABSTRACT

A signal processing apparatus includes: a communication unit; an audio processing unit; a video processing unit; and a controller which controls communication unit to transmit command to prepare for output of audio data and/or video data to external apparatus when mode for output to the external apparatus is selected, controls the audio processing unit and/or the video processing unit to interrupt output of the audio data and/or the video data when the external apparatus has been ready to output the audio data and/or the video data, and controls the communication unit to transmit the audio data and/or the video data to the external apparatus. With this configuration, it is possible to minimize a sound confusion state caused by simultaneous operation of the signal processing apparatus and an external apparatus or a mute state caused by non-operation of both apparatuses at the time of switching an output to the external apparatus.

### CROSS-REFERENCE TO RELATED APPLICATIONS

This application claims priority from Korean Patent Application No. 10-2008-0126569, filed on Dec. 12, 2008 in the Korean Intellectual Property Office, the disclosure of which is incorporated herein by reference.

### BACKGROUND OF INVENTION

1. Field of Invention

Apparatuses and methods consistent with the present invention relate to a signal processing apparatus, an audio apparatus, and a method of controlling the same, and more particularly, to a signal processing apparatus, an audio apparatus, and a method of controlling the same, which are capable of minimizing a confusion state caused by simultaneous operation of the signal processing apparatus and an external apparatus or a vacuum state caused by non-operation of both apparatuses at the time of switching an output to the external apparatus.

2. Description of the Related Art

In the related art, when audio data is switched from an internal speaker of a TV to an external home theater, the home theater is switched to an output mode after the internal speaker is muted. In this case, if the home theater has been in a turn-off state, there is a need of time for booting. Accordingly, a user will hear no sound until booting of the home theater is completed.

For the purpose of overcoming this problem, if the user mutes the internal speaker unconditionally after a predetermined delay time, the internal speaker and the external home theater are simultaneously operated to cause the user to hear a unwanted mixed sound. Moreover, the delay time may be varied depending on the kind and conditions of audio apparatus, the kind of audio signals, etc.

### SUMMARY OF THE INVENTION

Accordingly, it is an aspect of the present invention to provide a signal processing apparatus, an audio apparatus, and a method of controlling the same, which are capable of minimizing a confusion state caused by simultaneous operation of the signal processing apparatus and an external apparatus or a vacuum state caused by non-operation of both apparatuses at the time of switching an output to the external apparatus.

Additional aspects of the present invention will be set forth in part in the description which follows and, in part, will be obvious from the description, or may be learned by practice of the present invention.

The foregoing and/or other aspects of the present invention can be achieved by providing a signal processing apparatus including: a communication unit which communicates with an external apparatus; an audio processing unit which processes and outputs audio data; a video processing unit which processes and outputs video data; and a controller which controls the communication unit to transmit a command to prepare for output of the audio data and/or the video data to the external apparatus when a mode for output to the external apparatus is selected, controls the audio processing unit and/or the video processing unit to interrupt output of the audio data and/or the video data when the external apparatus has been ready to output the audio data and/or the video data, and controls the communication unit to transmit the audio data and/or the video data to the external apparatus.

In the signal processing apparatus, the controller may control the communication unit to transmit a control signal, which causes the audio data and/or the video data to be output, to the external apparatus when the external apparatus has been ready to output the audio data and/or the video data. In the signal processing apparatus, the mode for output to the external apparatus may include one of a mode for audio output to the external apparatus, a mode for video output to the external apparatus, and a mode for audio/video output to the external apparatus. In the signal processing apparatus, the controller may control the interruption of output of the audio data and/or the video data of the audio processing unit and/or the video processing unit and the transmission of the audio data and/or the video data to the external apparatus to be performed simultaneously. In the signal processing apparatus, the controller may determine at least one of whether the external apparatus is connected to the signal processing apparatus, whether the external apparatus is powered on, whether booting of the external apparatus has been completed, and whether the external apparatus has been ready to receive/transmit data to confirm whether or not the external apparatus has been ready to output the audio data and/or video data. In the signal processing apparatus, the communication unit may conduct communication with the external apparatus through High Definition Multimedia Interface Consumer Electronics Control (HDMI CEC) or an auxiliary channel to confirm whether or not the external apparatus has been ready to output audio data and/or video data.

The foregoing and/or other aspects of the present invention can be achieved by providing an audio apparatus including: a transceiver which communicates with a signal processing apparatus; a speaker unit which processes and outputs audio data; and a central processing unit which controls the transceiver to prepare for output of the audio data upon receiving a command to prepare for output of the audio data from the signal processing apparatus, inform the signal processing apparatus of completion of output preparation of the audio data, and receive the audio data transmitted by the signal processing apparatus, and controls the speaker unit to output the received audio data.

In the audio apparatus, the central processing unit may control the speaker unit to output the audio data transmitted by the signal processing apparatus upon receiving a control signal, which causes the audio data to be output, from the signal processing apparatus. In the audio apparatus, the central processing unit may determine at least one of whether the audio apparatus is connected to the signal processing apparatus, whether the audio apparatus is powered on, whether booting of the audio apparatus has been completed, and whether the audio apparatus has been ready to receive/transmit data to confirm whether or not the audio apparatus has been ready to output the audio data. In the audio apparatus, the transceiver may conduct communication with the signal processing apparatus through HDMI CEC or auxiliary channel to confirm whether or not the audio apparatus has been ready to output the audio data.

The foregoing and/or other aspects of the present invention can be achieved by providing a control method of a signal processing apparatus, including: transmitting a command to prepare for output of audio data and/or video data to an external apparatus when a mode for output to the external apparatus is selected; and, when the external apparatus has been ready to output the audio data and/or the video data, controlling the signal processing apparatus to interrupt output of the audio data and/or the video data, and transmitting the audio data and/or the video data to the external apparatus.

The control method may further include transmitting a control signal, which causes the audio data and/or the video data to be output, to the external apparatus when the external apparatus has been ready to output the audio data and/or the video data. In the control method, the mode for output to the external apparatus may include one of a mode for audio output to the external apparatus, a mode for video output to the external apparatus, and a mode for audio/video output to the external apparatus. In the control method, the interruption of output of the audio data and/or the video data of the audio processing unit and/or the video processing unit and the transmission of the audio data and/or the video data to the external apparatus may be performed simultaneously. The control method may further include determining at least one of whether the external apparatus is connected to the signal processing apparatus, whether the external apparatus is powered on, whether booting of the external apparatus has been completed, and whether the external apparatus has been ready to receive/transmit data to confirm whether the external apparatus has been ready to output the audio data and/or video data. In the control method, communication may be conducted with the external apparatus through HDMI CEC or auxiliary channel to confirm whether or not the external apparatus has been ready to output audio data and/or video data.

The foregoing and/or other aspects of the present invention can be achieved by providing a control method of an audio apparatus, including: preparing for output of audio data upon receiving a command to prepare for output of the audio data from a signal processing apparatus; upon completing output preparation of the audio data, informing the signal processing apparatus of the completion of output preparation of the audio data; and receiving the audio data transmitted by the signal processing apparatus and outputting the received audio data.

The control method may further include outputting the audio data transmitted by the signal processing apparatus upon receiving a control signal, which causes the audio data to be output, from the signal processing apparatus. The control method may further include determining at least one of whether the audio apparatus is connected to the signal processing apparatus, whether the audio apparatus is powered on, whether booting of the audio apparatus has been completed, and whether the audio apparatus has been ready to receive/transmit data to confirm whether the audio apparatus has been ready to output the audio data. In the control method, communication may be conducted with the signal processing apparatus through HDMI CEC or auxiliary channel to confirm whether or not the audio apparatus has been ready to output the audio data.

According to an aspect of the invention, when an output to an external audio apparatus such as a home theater is selected, by muting an internal speaker of a TV and transmitting audio data to the home theater after confirming whether or not audio can be transmitted from the theater, it is possible to minimize a sound confusion state or a mute state caused at the time of output switching, allowing a user to hear a definite sound within a relatively short and constant period of time.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a view showing a configuration of a signal processing apparatus according to an exemplary embodiment of the present invention.

FIG. 2 is a view showing a configuration of an audio apparatus according to an exemplary embodiment of the present invention.

FIGS. 3A and 3B are views showing an example of a communication channel between a signal processing apparatus and an audio apparatus according to an exemplary embodiment of the present invention.

FIG. 4 is a view showing a control process between a signal processing apparatus and an audio apparatus according to a first exemplary embodiment of the present invention.

FIG. 5 is a view showing a control process between a signal processing apparatus and a video apparatus according to a second exemplary embodiment of the present invention.

FIG. 6 is a view showing a control process between a signal processing apparatus and an output apparatus according to a third exemplary embodiment of the present invention.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, so that those in the art can easily practice the present invention. The present invention is not limited to exemplary embodiment disclosed herein but may be implemented in different forms. In the following exemplary embodiments, for the purpose of clarity, the same components are denoted by the same reference numerals throughout the drawings, and explanation thereof will be representatively given in a first exemplary embodiment but will be omitted in other exemplary embodiments.

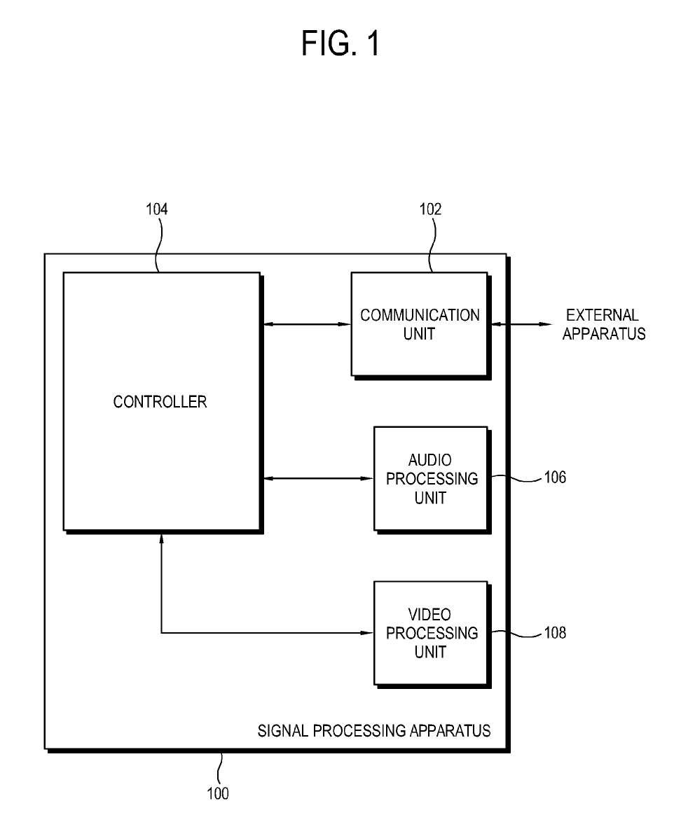

FIG. 1 is a view showing a configuration of a signal processing apparatus according to an exemplary embodiment of the present invention.

A signal processing apparatus 100 according to an exemplary of the invention may be any of a digital TV, a desk-top computer, a set-top box, a digital versatile disc (DVD) player, a DVD recorder, a Blu-ray disc player, and other electronic devices known in the art as long as they can process both of audio data and image data.

Referring to FIG. 1, the signal processing apparatus 100 may include a communication unit 102, a controller 104, an audio processing unit 106, and an image processing unit 108.

The communication unit 102 communicates with an external apparatus. Specifically, the communication unit 102 may transmit a command to prepare for output of audio data and/or image data to the external apparatus. The communication unit 102 may also transmit the audio data and/or image data to the external apparatus.

The external device may be any of a home theater, a monitor, a digital TV, and other electronic devices known in the art as long as they can output audio data and/or image data. Specifically, examples of the external apparatus may include an audio apparatus for outputting audio data, a video apparatus for outputting video data, an output apparatus for outputting both of audio data and video data, etc.

In addition, the communication unit 102 may conduct communication with the external apparatus through HDMI CEC or an auxiliary channel to confirm whether or not the external apparatus is or has been ready to output audio data and/or video data.

According to an exemplary embodiment, upon confirming that the external apparatus is or has been ready to output audio data and/or video data, the communication unit 102 may transmit a control signal to the external apparatus, which causes the audio data and/or video data to be output.

If a user selects a mode for output to the external apparatus, the controller 104 controls the communication unit 102 to transmit a command to prepare for output of the audio data and/or image data to the external apparatus. In this case, the mode for output to the external apparatus may include, for example, one of a mode for audio output to the external apparatus, a mode for video output to the external apparatus and a mode for audio and video output to the external apparatus.

In addition, the controller 104 may determine at least one of whether or not the external apparatus is connected to the signal processing apparatus 100, whether or not the external apparatus is powered on, whether or not booting of the external apparatus has been completed, and whether or not the external apparatus is or has been ready to receive/transmit data to confirm whether or not the external apparatus is or has been ready to output the audio data and/or video data.

In addition, upon confirming that the external apparatus is or has been ready to output the audio data and/or video data, the controller 104 controls the audio processing unit 106 and/or the video processing unit 108 to interrupt output of the audio data and/or video data and controls the communication unit 102 to transmit the audio data and/or video data to the external apparatus through the communication unit 102.

In this case, the controller 104 may control the interruption of output of the audio data and/or video data of the audio processing unit 106 and/or video processing unit 108 and the transmission of the audio data and/or video data to the external to be performed at once.

According to an exemplary embodiment, upon confirming that the external apparatus is or has been ready to output the audio data and/or video data, the controller 104 may control the communication unit 102 to transmit to the external apparatus, a control signal, which causes the audio data and/or video data to be output at the external apparatus. In this case, upon receiving the control signal which causes the audio data and/or video data to be output, from the signal processing apparatus 100, the external apparatus starts to output the audio data and/or video data transmitted by the signal processing apparatus 100.

According to another exemplary embodiment, the controller 104 may not transmit to the external apparatus, a control signal, which causes the audio data and/or video data to be output at the external apparatus. In this case, if the external apparatus is or has been ready to output the audio data and/or video data, the external apparatus starts to output the audio data and/or video data transmitted by the signal processing apparatus 100.

In addition, the controller 104 may control the video processing unit 108 to display the mode for output to the external apparatus in the form of OSD (On Screen Display).

The audio processing unit 106 processes and outputs the audio data. Specifically, the audio processing unit 106 may output the processed audio data through a speaker. To this end, the audio processing unit 106 may further include an internal speaker.

In addition, the audio processing unit 106 may interrupt output of the audio data. Specifically, the audio processing unit 106 may mute the internal speaker in a hardware manner or turns off an audio data processing circuit in a circuit manner to prevent the audio data from being output.

The video processing unit 108 processes and outputs the video data. Specifically, the video processing unit 108 may perform scaling and/or brightness adjustment for the video data for display. To this end, the video processing unit 108 may include a liquid crystal display (LCD), an organic light emitting display (OLED), a plasma display panel (PDP), or the like.

In addition, the video processing unit 108 may interrupt output of the video data. Specifically, the video processing unit 108 may turn off a monitor power source in a hardware manner or turns off a video data processing circuit in a circuit manner to prevent the video data from being output.

The video processing unit 108 may display the mode for output to the external apparatus in the form of OSD. In this case, the user may select the mode for output to the external apparatus, which is desired to be switched, on the OSD.

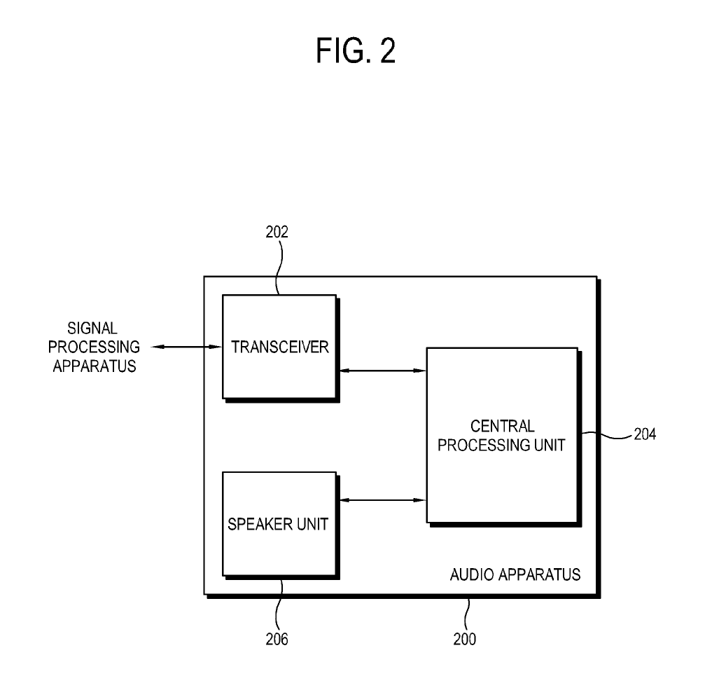

FIG. 2 is a view showing a configuration of an audio apparatus 200 according to an exemplary embodiment of the present invention.

An audio apparatus 200 is an external apparatus for output audio data.

According to an exemplary embodiment of the invention, the audio apparatus 200 may include a transceiver 202, a central processing unit 204 and a speaker unit 206.

The transceiver 202 communicates with the signal processing apparatus 100. Specifically, the transceiver 202 may receive a command from the signal processing apparatus 100 to prepare for output of the audio data. In addition, the transceiver 202 may receive the audio data transmitted by the signal processing apparatus 100.

In addition, the transceiver 202 may conduct communication with the signal processing apparatus 100 through HDMI CEC or an auxiliary channel (AUX CH) to notify whether or not the audio apparatus 200 is or has been ready to output the audio data.

Upon receiving the command to prepare for output of the audio data from the signal processing apparatus 100, the central processing unit 204 becomes ready to output the audio data.

In addition, upon being or having been ready to output the audio data, the central processing unit 204 informs the signal processing apparatus 100 of completion of preparation for output of the audio data and controls the transceiver 202 to receive the audio data transmitted by the signal processing apparatus 100. In this case, the central processing unit 204 controls the speaker unit 206 to output the received audio data.

In addition, the central processing unit 204 may determine at least one of whether or not the audio apparatus 200 is connected to the signal processing apparatus 100, whether or not the audio apparatus 200 is powered on, whether or not booting of the audio apparatus 200 has been completed, and whether or not the audio apparatus 200 is or has been ready to receive/transmit data to confirm whether or not the audio apparatus 200 is or has been ready to output the audio data.

According to an exemplary embodiment, upon receiving a control signal from the signal processing apparatus 100, which causes the audio data to be output, the central processing unit 204 may control the speaker unit 206 to output the audio data transmitted by the signal processing apparatus 100.

According to another exemplary embodiment, upon having been ready to output the audio data, the central processing unit 204 may control the speaker unit 206 to output the audio data transmitted by the signal processing apparatus 100. In this case, the signal processing apparatus 100 does not transmit the control signal to the audio apparatus 200, which causes the audio data to be output.

The speaker unit 206 processes and outputs the audio data. Specifically, the speaker unit 206 may output the processed audio data through a speaker of the audio apparatus 200. To this end, the speaker unit 206 may further include the speaker.

Only the configuration of the audio apparatus has been illustrated in the above. However, a video apparatus for outputting video data, an output apparatus for outputting both of audio data and video data, etc. may be also similarly implemented with the configuration of FIG. 2.

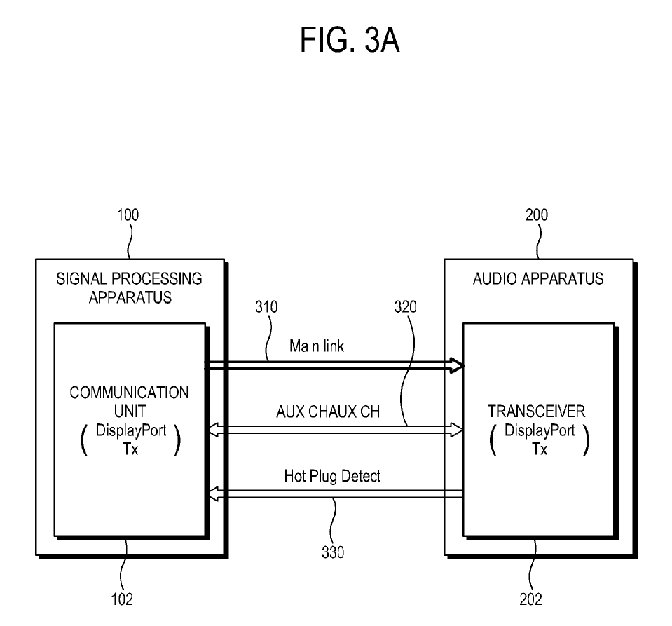

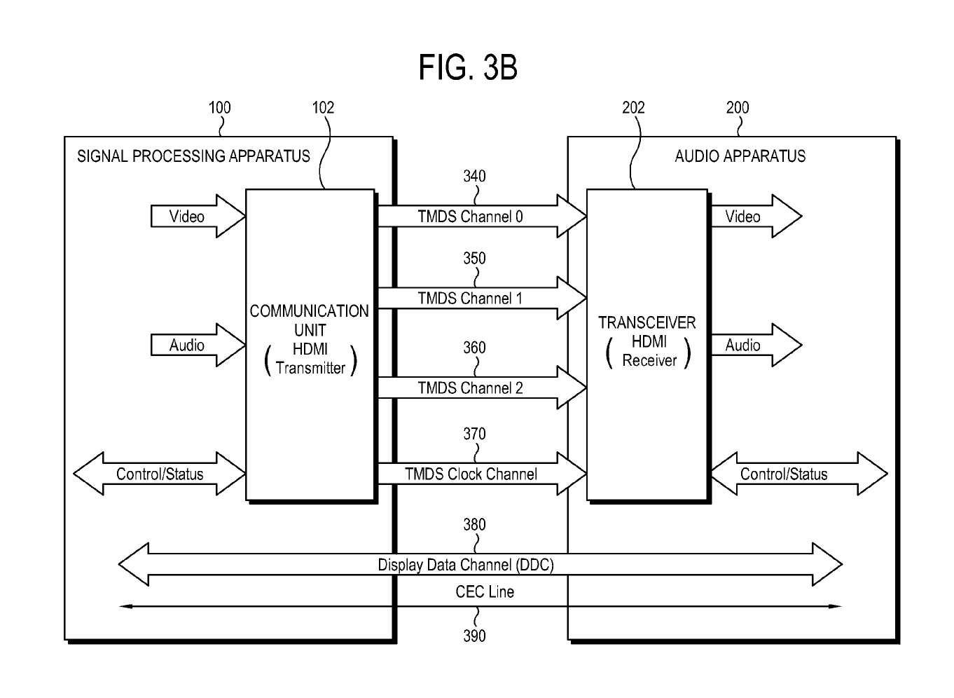

FIGS. 3A and 3B are views showing an example of a communication channel between a signal processing apparatus and an audio apparatus according to an exemplary embodiment of the present invention.

If audio data is output through the audio apparatus 200 instead of the signal processing apparatus 100, in the exemplary embodiment of the present invention, after confirming whether or not the audio apparatus 200 is or has been ready to output the audio data, the signal processing apparatus 100 interrupts output of the audio data and the audio apparatus 200 starts to output the audio data. To this end, the signal processing apparatus 100 and the audio apparatus 200 has to conduct communication for mutual control. In the exemplary embodiment of the present invention, a communication channel is divided into a communication channel for communicating with the audio apparatus 200 for control and a communication channel for communicating with the audio apparatus 200 for transmission of audio data.

In FIG. 3A, the signal processing apparatus 100 and the audio apparatus 200 conduct mutual communication according to a DisplayPort standard.

In this case, the signal processing apparatus 100 and the audio apparatus 200 use an AUX channel 320 as a transmission line of control command. As one example, the signal processing apparatus 100 may transmit a command to the audio apparatus 200 through the AUX channel 320, to prepare for output of audio data or a control signal, which causes the audio data to be output. In addition, the signal processing apparatus 100 may exchange information about whether or not booting of the audio apparatus 200 is or has been completed or whether or not the audio apparatus 200 is or has been ready to receive or transmit data through the AUX channel 320 to confirm whether or not the audio apparatus 320 is or has been ready to output the audio data.

On the other hand, the signal processing apparatus 100 and the audio apparatus 200 use a main link channel 310 as a transmission line of audio data.

In the meantime, the signal processing apparatus 100 and the audio apparatus 200 exchange information about whether or not the audio apparatus 200 is connected to the signal processing apparatus 100, whether or not the audio apparatus 200 is powered on, etc., through a Hot Plug Detect channel 330.

In FIG. 3B, the signal processing apparatus 100 and the audio apparatus 200 conduct mutual communication according to a HDMI standard.

In this case, the signal processing apparatus 100 and the audio apparatus 200 use a CEC line channel 390 as a transmission line of control command. As one example, the signal processing apparatus 100 may transmit a command to the audio apparatus 200 through the CEC line channel 390, to prepare for output of audio data or a control signal, which causes the audio data to be output. In addition, the signal processing apparatus 100 may exchange information about whether or not booting of the audio apparatus 200 has been completed or whether or not the audio apparatus 200 is or has been ready to receive/transmit data through the CEC line channel 390 to confirm whether or not the audio apparatus 320 is or has been ready to output the audio data.

On the other hand, the signal processing apparatus 100 and the audio apparatus 200 use three channels, i.e., a TMDS channel 0 340, a TMDS channel 1 350 and a TMDS channel 2 360, as transmission lines of audio data.

In the meantime, the signal processing apparatus 100 and the audio apparatus 200 exchange information about whether or not the audio apparatus 200 is connected to the signal processing apparatus 100, whether or not the audio apparatus 200 is powered on, etc., through a TMDS Clock channel 370.

FIGS. 3A and 3B show only one example of communication conducted between the signal processing apparatus 100 and the audio apparatus 200. Therefore, the signal processing apparatus 100 and the audio apparatus 200 may exchange audio data and a control command through different communication. For example, SPDIF (Sony Philips Digital Interface) may be used as a transmission line of audio data.

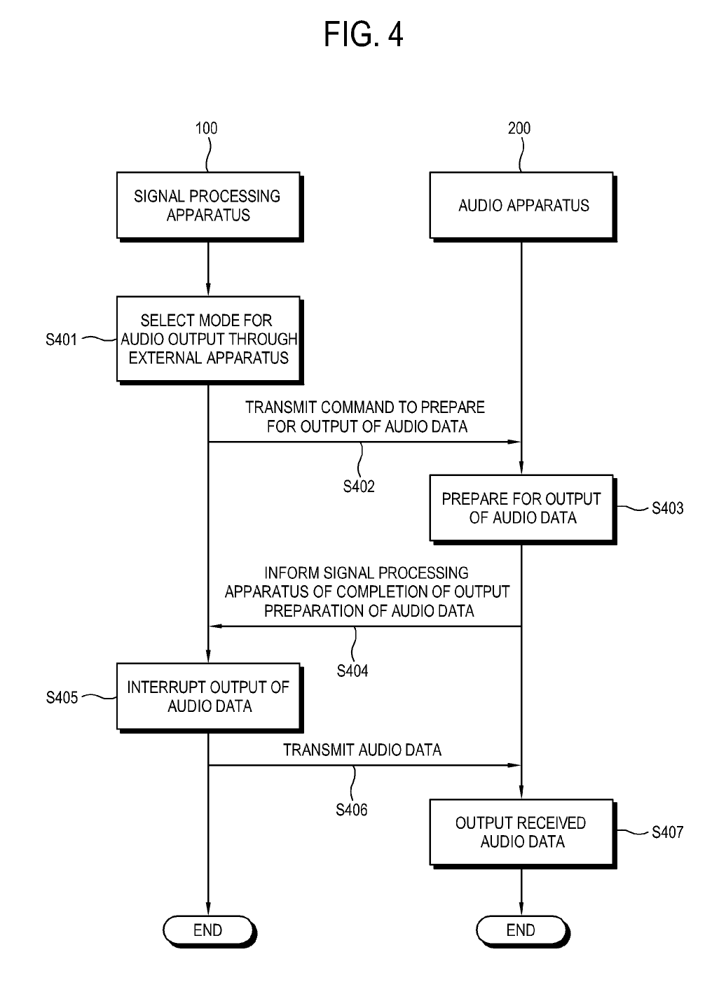

FIG. 4 is a view showing a control process between a signal processing apparatus and an audio apparatus according to a first exemplary embodiment of the present invention.

A first exemplary embodiment is related to a case where a mode for audio output to an external apparatus is selected. For example, on watching a broadcasting program with a digital TV, audio may be output through the audio apparatus 200 such as a home theater or the like, instead of an internal speaker of the digital TV.

When the mode for audio output through an external apparatus is selected (S401), the signal processing apparatus 100 transmits a command to prepare for output of audio data (S402).

In this case, the audio apparatus 200 is ready to output the audio data (S403). Specifically, the audio apparatus 200 is connected to the signal processing apparatus 100, or the audio apparatus 200 is powered on to boot the audio apparatus 200. In addition, the audio apparatus 200 may perform a signal synchronization operation to complete preparation of data reception/transmission.

Upon completing the preparation of audio data for output, the audio apparatus 200 informs the signal processing apparatus 100 of the completion of preparation for output of the audio data (S404).

In the meantime, upon transmitting the command to prepare for transmission of the audio data to the audio apparatus 200 or informing the signal processing apparatus 100 of the completion of preparation for output of the audio data, the signal processing apparatus 100 and the audio apparatus 200 may conduct mutual communication through an AUX channel or a CEC line channel.

Upon being informed of the completion of preparation for output of the audio data from the audio apparatus 200, the signal processing apparatus 100 interrupts output of the audio data (S405). Specifically, the signal processing apparatus 100 may mute an internal speaker in a hardware manner or turns off an audio data processing circuit in a circuit manner to prevent the audio data from being output.

In this case, the signal processing apparatus 100 starts to transmit the audio data to the audio apparatus 200 (S406).

In the meantime, the signal processing apparatus 100 may perform the operation S405 and the operation S406 simultaneously to achieve the interruption of output of the audio data in the signal processing apparatus 100 and the transmission of audio data to the audio apparatus 200 simultaneously.

The audio apparatus 200 outputs the audio data received from the signal processing apparatus 100 (S407).

While watching video with a TV, a user may hear audio through an audio apparatus having a good audio output characteristic. For example, if audio is output through a home theater having the ability to output multi-channel audio of a 5.1 channel, more stereophonic audio can be reproduced and output.

According to the first exemplary embodiment of the present invention, after confirming whether or not the home theater can output audio, an internal speaker of the TV is muted and the audio starts to be transmitted to the home theater. Accordingly, it is possible to minimize a sound confusion state caused by simultaneous operation of the internal speaker of the TV and a driving speaker of the home theater and or a mute state caused by non-operation of both speakers at the time of switching an output to the external apparatus.

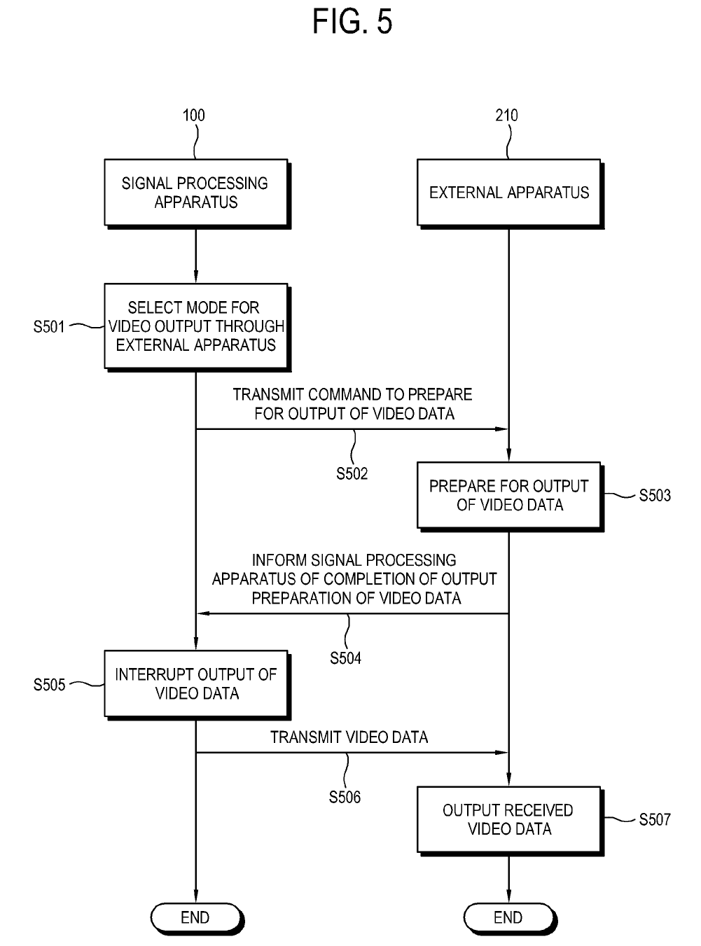

FIG. 5 is a view showing a control process between a signal processing apparatus and a video apparatus according to a second exemplary embodiment of the present invention.

A second exemplary embodiment is related to a case where a mode for video output through an external apparatus is selected. For example, on playing back contents with a PC, a user may output video through an external apparatus 210 such as a digital TV having high resolution and image quality, instead of a PC monitor having low resolution.

When a mode for video output through the external apparatus is selected (S501), the signal processing apparatus 100 transmits a command to prepare for output of video data (S502).

In this case, the external apparatus 210 is ready to output the video data (S503). Upon completing the preparation of output of video data, the external apparatus 210 informs the signal processing apparatus 100 of the completion of preparation for output of the video data (S504).

Upon being informed of the completion of preparation for output of the video data from the external apparatus 210, the signal processing apparatus 100 interrupts output of the video data (S505). Specifically, the signal processing apparatus 100 may turn off a monitor power source in a hardware manner or turns off a video data processing circuit in a circuit manner to prevent the video data from being output.

In this case, the signal processing apparatus 100 starts to transmit the video data to the external apparatus 210 (S506).

In the meantime, the signal processing apparatus 100 may perform the operation S505 and the operation S506 simultaneously to achieve the interruption of output of the video data in the signal processing apparatus 100 and the transmission of video data to the external apparatus 210 simultaneously.

The external apparatus 210 outputs the video data received from the signal processing apparatus 100 (S507).

According to the second exemplary embodiment of the present invention, after confirming whether or not the external apparatus can output video, the video output to the signal processing apparatus is interrupted and the video starts to be transmitted to the external apparatus. Accordingly, it is possible to minimize a video vacuum state caused by non-operation of both of the signal processing apparatus and external apparatus at the time of switching a video output to the external apparatus.

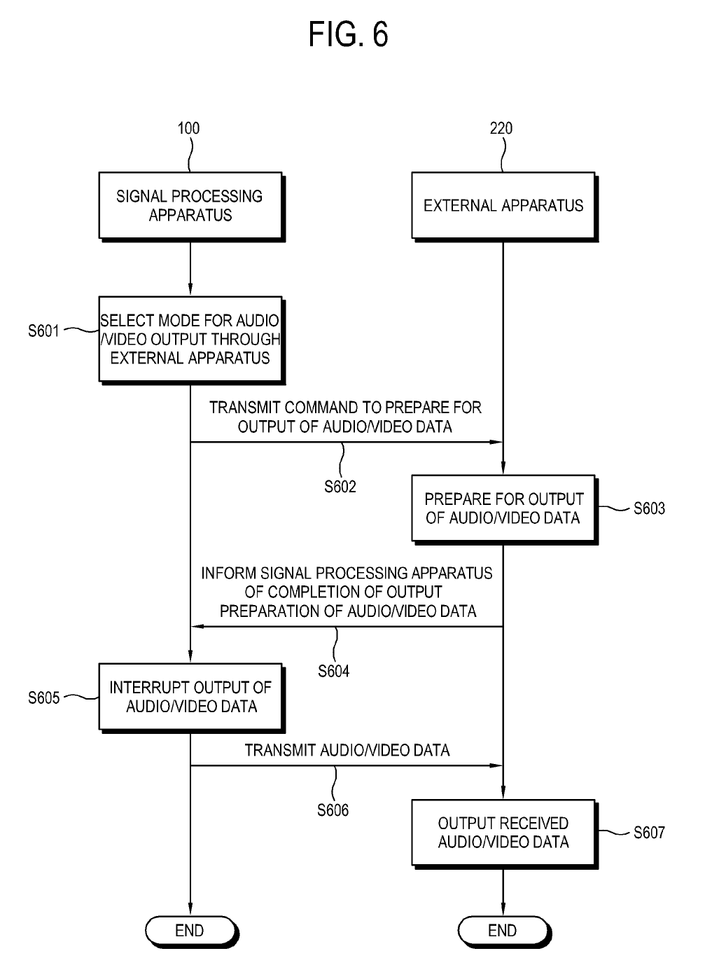

FIG. 6 is a view showing a control process between a signal processing apparatus and an output apparatus according to a third exemplary embodiment of the present invention.

A third exemplary embodiment is related to a case where a mode for audio/video output to an external apparatus is selected. For example, on playing back contents with a PC, a user may output both video and audio through an external apparatus 220 such as a digital TV.

When a mode for audio/video output to the external apparatus is selected (S601), the signal processing apparatus 100 transmits a command to prepare for output of audio/video data (S602).

In this case, the external apparatus 220 is ready to output the audio/video data (S603). Upon completing the preparation of output of audio/video data, the external apparatus 220 informs the signal processing apparatus 100 of the completion of preparation for output of the audio/video data (S604).

Upon being informed of the completion of preparation for output of the audio/video data from the external apparatus 220, the signal processing apparatus 100 interrupts output of the audio/video data (S605). Specifically, the signal processing apparatus 100 may mute an internal speaker in a hardware manner or turns off an audio data processing circuit in a circuit manner to prevent the audio data from being output. In addition, the signal processing apparatus 100 may turn off a monitor power source in a hardware manner or turns off a video data processing circuit in a circuit manner to prevent the video data from being output.

In this case, the signal processing apparatus 100 starts to transmit the audio/video data to the external apparatus 220 (S606).

In the meantime, the signal processing apparatus 100 may perform the operation S605 and the operation S606 simultaneously to achieve the interruption of output of the audio/video data in the signal processing apparatus 100 and the transmission of audio/video data to the external apparatus 220 simultaneously.

The external apparatus 220 outputs the audio/video data received from the signal processing apparatus 100 (S607).

According to the third exemplary embodiment of the present invention, after confirming whether or not the external apparatus can output audio and video, the audio/video output to the signal processing apparatus is interrupted and the audio/video starts to be transmitted to the external apparatus. Accordingly, it is possible to minimize an audio/video vacuum state caused by non-operation of both of the signal processing apparatus and external apparatus at the time of switching an audio/video output to the external apparatus. Further, it is possible to minimize a sound confusion state caused by simultaneous operation of the signal processing apparatus and external apparatus.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A signal processing apparatus comprising:
a communication unit which communicates with an external apparatus;
an audio processing unit which processes and outputs audio data;
a video processing unit which processes and outputs video data; and
a controller which controls the communication unit to transmit a command to the external apparatus for the external apparatus to prepare for a second output of at least one of the audio data and the video data if a mode for output through the external apparatus is selected, controls at least one of the audio processing unit and the video processing unit to interrupt a first output of the at least one of the audio data and the video data if the external apparatus is ready for the second output the of at least one of the audio data and the video data, and controls the communication unit to transmit the at least one of the audio data and the video data to the external apparatus.

2. The signal processing apparatus according to claim 1, wherein the controller controls the communication unit to transmit a control signal to the external apparatus, which causes the second output of at least one of the audio data and the video data if the external apparatus is ready for the second output of at least one of the audio data and the video data.

3. The signal processing apparatus according to claim 1, wherein the mode for output through the external apparatus includes one of a mode for audio output through the external apparatus, a mode for video output through the external apparatus, and a mode for audio and video output through the external apparatus.

4. The signal processing apparatus according to claim 1, wherein the controller controls the interrupting the first output of the at least one of the audio data and the video data of the at least one of the audio processing unit and the video processing unit and the transmitting the at least one of the audio data and the video data to the external apparatus to be performed simultaneously.

5. The signal processing apparatus according to claim 1, wherein the controller determines at least one of whether the external apparatus is connected to the signal processing apparatus, whether the external apparatus is powered on, whether booting of the external apparatus is completed, and whether the external apparatus is ready to receive or transmit data to confirm whether the external apparatus is ready for the second output of the at least one of the audio data and the video data.

6. The signal processing apparatus according to claim 1, wherein the communication unit conducts communication with the external apparatus through High Definition Multimedia Interface Consumer Electronics Control (HDMI CEC) channel or an auxiliary channel to confirm whether the external apparatus is ready to output the at least one of the audio data and the video data.

7. An audio apparatus comprising:
a transceiver which communicates with a signal processing apparatus;
a speaker unit which processes and outputs audio data; and
a central processing unit which prepares for output of the audio data upon receiving a command from the signal processing apparatus, to prepare for output of the audio data, and controls the transceiver to inform the signal processing apparatus of a completion of the preparing of output of the audio data and then to receive the audio data transmitted by the signal processing apparatus, and controls the speaker unit to output the received audio data upon the completion of the preparing of output of the audio data.

8. The audio apparatus according to claim 7, wherein the central processing unit controls the speaker unit to output the audio data transmitted by the signal processing apparatus, upon receiving a control signal.

9. The audio apparatus according to claim 7, wherein the central processing unit determines at least one of whether the audio apparatus is connected to the signal processing apparatus, whether the audio apparatus is powered on, whether booting of the audio apparatus is completed, and whether the audio apparatus is ready to receive or transmit data to confirm whether the audio apparatus is ready to output the audio data.

10. The audio apparatus according to claim 7, wherein the transceiver conducts communication with the signal processing apparatus through High Definition Multimedia Interface Consumer Electronics Control (HDMI CEC) channel or an auxiliary channel to confirm whether the audio apparatus is ready to output the audio data.

11. A control method of a signal processing apparatus, comprising:
transmitting a command to an external apparatus to prepare for a second output of at least one of audio data and video data if a mode for output through the external apparatus is selected; and
if the external apparatus is ready for the second output of the at least one of the audio data and the video data, controlling a signal processing apparatus to interrupt a first output of the at least one of the audio data and the video data, and transmitting the at least one of the audio data and the video data to the external apparatus.

12. The control method according to claim 11, further comprising transmitting a control signal to the external apparatus, which causes the second output of at least one of the audio data and the video data to be output when the external apparatus is ready to output the at least one of the audio data and the video data.

13. The control method according to claim 11, wherein the mode for output through the external apparatus includes one of a mode for audio output through the external apparatus, a mode for video output through the external apparatus, and a mode for audio and video output through the external apparatus.

14. The control method according to claim 11, wherein the interrupting the first output of the at least one of the audio data and the video data of the signal processing apparatus and the transmitting of the at least one of the audio data and the video data to the external apparatus are performed substantially simultaneously.

15. The control method according to claim 11 further comprising determining at least one of whether the external apparatus is connected to the signal processing apparatus, whether the external apparatus is powered on, whether booting of the external apparatus is completed, and whether the external apparatus is ready to receive or transmit data to confirm whether the external apparatus is ready for the second output of the at least one of the audio data and video data.

16. The control method according to claim 11, wherein communication is conducted with the external apparatus through High Definition Multimedia Interface Consumer Electronics Control (HDMI CEC) channel or an auxiliary channel to confirm whether the external apparatus is ready for the second output of at least one of the audio data and video data.

17. A control method of an audio apparatus, comprising:
preparing for an output of audio data upon receiving a command from the signal processing apparatus to prepare for output of the audio data;
upon completing the preparing for the output of the audio data, informing the signal processing apparatus of the completing the preparing for the output of the audio data; and
receiving the audio data transmitted by the signal processing apparatus and outputting the received audio data.

18. The control method according to claim 17, further comprising outputting the audio data transmitted by the signal processing apparatus upon receiving a control signal from the signal processing apparatus, which causes the audio data to be output.

19. The control method according to claim 17, further comprising determining at least one of whether the audio apparatus is connected to the signal processing apparatus, whether the audio apparatus is powered on, whether booting of the audio apparatus is completed, and whether the audio apparatus is ready to receive or transmit data to confirm whether the audio apparatus is ready to output the audio data.

20. The control method according to claim 17, wherein communication is conducted with the signal processing apparatus through High Definition Multimedia Interface Consumer Electronics Control (HDMI CEC) channel or an auxiliary channel to confirm whether the audio apparatus is ready to output the audio data.

21. A control method of switching at least one of audio and video output, the method comprising:
receiving a first signal for switching an output of the at least one of audio and video from a first device to a second device;
transmitting a second signal based on the first signal, to the second device, to set the second device to output the at least one of audio and video; and
switching the output of the at least one of audio and video from the first device to the second device when the second device is set to output the at least one of the audio and video.

22. The control method of claim 21, wherein when the second device is set to output the at least one of the audio and video, a third signal is transmitted by the second device to indicate that the second device is set to output the at least one of audio and video, and the switching is based on the third signal.

23. The control method of claim 22, wherein the first device is a display apparatus which performs the receiving the first signal, the transmitting the second signal, and the switching the output, and further receives the third signal,

24. The control method of claim 23, wherein the second and the third signals are transmitted through a High Definition Multimedia Interface Consumer Electronics Control.
